(19) United States
(12) Patent Application Publication
(10) Pub. No.: US 2007/0187864 A1
(43) Pub. Date: Aug. 16, 2007

(54) System and method for manufacturing and constructing a mold for use in generating cast polymer products resembling natural stonework

(76) Inventors: Kenneth Mincey, Cumming, GA (US); Donna Mincey Collins, Cumming, GA (US)

Correspondence Address: CLEMENTS WALKER, 1901 ROXBOROUGH ROAD, SUITE 300, CHARLOTTE, NC, 28211, US

(21) Appl. No.: 11/351,855

(22) Filed: Feb. 11, 2006

(51) Int. Cl. B29C 33/40

(52) U.S. Cl. 264/219

(57) ABSTRACT

The present invention provides a method for manufacturing a mold to be used in creating cast polymer products such as cultured marble and cultured granite, particularly used as walls surrounding bathroom showers and bathtubs, but applicable to many other industries as well, using original natural stone materials to make the mold. The method of manufacturing the hardened mold resembling the appearance of natural stonework for use in constructing panels of molded cast polymer is comprised of arranging natural stonework material in a predetermined pattern and securing the natural stonework material to a backing to hold the stonework material in the predetermined pattern and applying material between a plurality of edges of the natural stonework material to simulate a texture to a plurality of stone gaps surrounding the natural stonework material. The method may additionally include the application of various layers of sealant, gel-coat, skim-coat, fiberglass, and resin.

### FIELD OF THE INVENTION

The present invention relates generally to the field of decorative cast polymer products used in the construction industry and particularly to such materials as are used as a replacement for marble and the like. More specifically the present invention relates to a method for manufacturing and constructing a mold to be used in creating cast polymer products such as cultured marble and cultured granite, particularly used as walls surrounding bathroom showers and bathtubs, using natural stonework to construct the mold.

### BACKGROUND OF THE INVENTION

Numerous disadvantages exist to using actual stonework or tile for decorative display in bathroom showers, bathtubs, and the like. Natural stone is porous and has natural fissures. Over time, use of such a natural stone product may deteriorate, mildew, and/or crack. Cast polymer products, such as cultured marble, on the other hand, are not porous, are easily cleaned, and do not mildew. Thus, there are numerous advantages to using a cast polymer product such as cultured marble or cultured granite.

Cultured marble, for example, is made by chemically bonding mineral fillers, such as crushed marble, or the like, with polyester resins to create a matrix. This matrix is hardened to a solid material in a variety of predetermined shapes. To create such a cultured marble product, a mold first must be constructed into which the mineral filler and resins may be poured. Detail in the construction of this mold is critical in order to use the mold to create a final product that truly does have the appearance and textural feel of natural stonework.

In the prior art, many devices have been disclosed which use a mold. Many such devices do not ultimately create a finished cast polymer product in which natural features, such as veins, stone surface textures, and grout surface textures are present.

These and other problems exist. Previous attempts to solve these and other problems include the following:

Patent WO 83/02917 issued to Roberts on Sept. 1, 1983, discloses a process for the manufacture of a fiberglass, cultured marble, or onyx products which comprises: a) Storing suitable molds in a heated room at above 30 degrees C.; b) Moving the mold to an area where gel-coat is applied using standard equipment; c) Moving the mold to an area for the application of the required patterns to the “gel-coated” surface by means of silk screens made to a predetermined design; d) Moving the mold to a mixing head area where components of the final products, comprising a resin mixture and catalyst, which are stored separately, are mixed and added to the mold to form the required article; e) The product mold complete with article is then moved to a demolding and storage area and after allowing for a curing time of about 20 minutes, the article is removed from the mold; f) The mold is then returned to the heated room, in (a) above, to complete the process cycle.

U.S. Pat. No. 4,244,993 issued to Platka, III et al. on Jan. 13, 1981, discloses an improved method for the manufacture of simulated marble and onyx products. The process comprises the steps of applying a substantially clear coating to a mold, applying a first layer of a mixture of polyester resin and filler over the coating, forming readily visible striations in the first layer of resin and filler, applying a layer of glass fibers thereover, applying a second layer of polyester resin and filler over the layer of glass fibers and permitting the various layers to completely cure so as to form the final product.

U.S. Pat. No. 3,773,886 issued to Starr et al. on Nov. 20, 1973, discloses a process for forming simulated marble (cultured marble) including applying a polyester gel-coat to a mold surface followed by successively applying vinyl and polyester veining and spatter compositions containing low-boiling solvents over the gel-coat with evaporation of substantial amounts of solvent from the respective compositions during the applying steps, then filling the remainder of the mold with resin and curing.

U.S. Pat. No. 4,209,486 issued to Ross on Jun. 24, 1980, discloses a process of inlaying a design in molded simulated marble or the like comprising the steps of applying a release coating to the inner bottom surface of a mold, applying a transparent gel-coat on said release coating, smoothing a piece of porous flexible sheet material bearing the design on one face thereof on the gel coat in the mold to conform to the surface of the gel coat with the one face of the piece of cloth bearing the design toward the gel coat, and casting a hardenable marble mix in the mold over the piece of cloth. The marble mix is then allowed to harden for removal of the resultant simulated marble slab from the mold, the piece of sheet material being embedded in the slab with the design viewable through the transparent gel-coat.

U.S. Pat. No. 6,231,938 issued to Gockel et al. on May 15, 2001, and U.S. Pat. No. 6,692,683 issued to Gockel et al. on Feb. 17, 2004 disclose multilayer polymeric shells for spas, bathtubs and shower enclosures having a textured and marbled surface layer. The shells are produced by forming by extrusion a multilayer polymeric sheet having a marbled appearing top layer, passing the sheet between rollers to impart a textured surface to the marbled top layer of the sheet, and thermoforming the sheets into the structural shells for spas, bathtubs and shower enclosures.

U.S. Pat. No. 6,841,105 issued Nehring et al. on Jan. 11, 2005, discloses a method of forming thermoplastic panels is disclosed which includes the steps of forming the thermoplastic panels by extrusion or a similar process and simultaneously or subsequently texturing or graining at least one face thereof, and utilizing such pre-textured or pre-grained panels to form a finished panel or article by disposing such panel in a thermoforming mold having at least one grained or textured mold surface against which the pre-textured or pre-grained surface of the panel is disposed and thermoforming such panel. The process provides a textured or grained surface having greatly improved uniformity and enhanced appearance.

U.S. Pat. No. 5,948,333 issued to Endres on Jan. 7, 1992, discloses a method for producing imitation marble fixtures such as tubs, walls, vanities, etc. comprising the steps of applying a first layer over a prepared mold which outlines the features of the desired product, wherein the first layer comprises a clear polyester gel-coat. Then applying a second layer over the first layer, the second layer comprises a pattern of swirls and veins permeated throughout a matching polyester gel-coat. Thereafter, applying a third layer over the second layer, the third layer comprises calcium carbonate with polyester resin for the purpose of providing the base color of the imitation marble fixture. Finally, applying a layer of polyurethane foam, wherein the polyurethane foam consists of equal parts of Polymeric Diphenylethane Diisocyanate and Polyol Tertiaryamine. Blending of the aforementioned materials produces a chemical reaction causing expansion of the components for the purpose of filling the mold thereby defining the fixture. The present invention provides a method which will create an imitation marble fixture in a much more time and cost efficient manner than previous methods such as that used to produce cultured marble. Further, the invention also provides a method which produces objects which have a weight only a fraction of the weight of similar objects made of cultured marble.

U.S. Pat. No. 4,656,722 issued to Armstrong on Apr. 14, 1987, discloses an improved method of forming a decorative panel of molded plastic comprising the steps of constructing a form having a detailed masonry surface; covering the detailed surface with a mold release material; applying a thin layer of gel-coat over the mold release; applying a plurality of layers of fiberglass matte and resin over the gel-coat layer; allowing the plurality of fiberglass matte and resin layers to harden thereby forming a heat resistant mold having a female side being formed against the detailed surface and a side opposite from the female side; removing the mold from the form; perforating the mold thereby providing fluid communication between the two sides; connecting a vacuum apparatus to the side opposite of the mold; placing a sheet of high impact plastic above and adjacent the female side of the mold; activating a heater thereby heating the plastic sheet to a pliable state; activating the vacuum apparatus thereby drawing the plastic sheet into the female side of the mold; and removing the formed panel from the mold.

While these patents and other previous devices and methods have attempted to solve the above mentioned problems, none have provided a method for manufacturing and constructing a mold to be used in creating cast polymer products resembling natural stonework, such as cultured marble and cultured granite, in the same manner as the present invention. Therefore, a need exists for such a system and method of manufacture and use.

### BRIEF SUMMARY OF THE INVENTION

In various embodiments, the present invention provides a method for manufacturing and constructing a mold to be used in creating cast polymer products such as cultured marble and cultured granite, particularly used as walls surrounding bathroom showers and bathtubs, but applicable to many other industries and markets as well, using original natural stone materials to make the mold.

In one exemplary embodiment, a method of manufacturing a hardened mold resembling the appearance of natural stonework for use in constructing panels of molded cast polymer is disclosed comprised of arranging natural stonework material on a mold in a predetermined pattern and securing the natural stonework material to a backing to hold the natural stone work material in the predetermined pattern and applying material between a plurality of edges of the natural stonework material to simulate a texture to a plurality of stone gaps surrounding the natural stonework material. This arrangement is placed on a flat table to affect the mold form. Grout is then applied to the cracks (grout lines) on the mold form. The mold form, consisting of the arrayed stone and grout is sealed and released with a polymer release system.

In another exemplary embodiment of the present invention, a method is disclosed which additionally includes applying one or more layers of a tooling gel-coat, applying one or more layers of a skim coat fiberglass, removing air bubbles by one of a rolling or brushing technique, applying one or more layers of a heavier fiberglass, applying one or more layers of a resin, using brushes and rollers to remove the trapped air, and allowing the layers to cure. A metal or wood frame is then applied to the back of the mold, to give the mold rigidity. Once the mold has cured, it is removed from the mold form. The mold is then allowed to cure further and it is released and sprayed with a tooling gel. The mold then has various layers of fiberglass and resin and waferboard applied, using brushes and rollers to remove trapped air. A wood or metal frame is then applied to the back of the master mold, to give the master mold rigidity. After the master mold has cured, it is removed from the mold. After the master mold has cured further, it is released and sprayed with tooling gel and the above steps of application of fiberglass, resin, waferboard, and framing are repeated. After the production mold has cured, it is removed from the master mold. After the production mold has cured further, it is released. The production mold is then sprayed with a production gel coat. After a pre-determined time, the mold is run along the conveyor lines to the pouring machine, and is filled with matrix material (cultured marble). The production mold is then moved to a curing area, using the conveyor lines. After the product is dried, it is removed from the production mold and is ready to be installed for use.

### BRIEF DESCRIPTION OF THE DRAWINGS

The present invention is illustrated and described herein with reference to preferred embodiments and examples thereof, in which like reference numbers denote like parts or components, and in which:

FIG. 1 is a top perspective view of a natural stone assembly according to an embodiment of the present invention;

FIG. 2 is a top perspective view of a natural stone assembly according to an embodiment of the present invention;

FIG. 3 is a top perspective view of a mold tray and conveyor system according to an embodiment of the present invention;

FIG. 4 is a top perspective view of a mold according to an embodiment of the present invention;

FIG. 5 is a side cross sectional view of the layers applied onto the mold while it is being made according to an embodiment of the present invention;

FIG. 6 is a top perspective view of a mold tray and conveyor system according to an embodiment of the present invention;

FIG. 7 is top perspective view of a mold tray and conveyor system according to an embodiment of the present invention; and

FIG. 8 is a front perspective view of a decorative panels made from the mold resembling a natural stone assembly according to an embodiment of the present invention.

### DETAILED DESCRIPTION OF THE INVENTION

Before explaining the disclosed embodiments of the present invention in detail, it is to be understood that the invention is not limited in its application to the details of the particular arrangement shown since the invention is capable of other embodiments. Also, the terminology used herein is for the purpose of description and not of limitation.

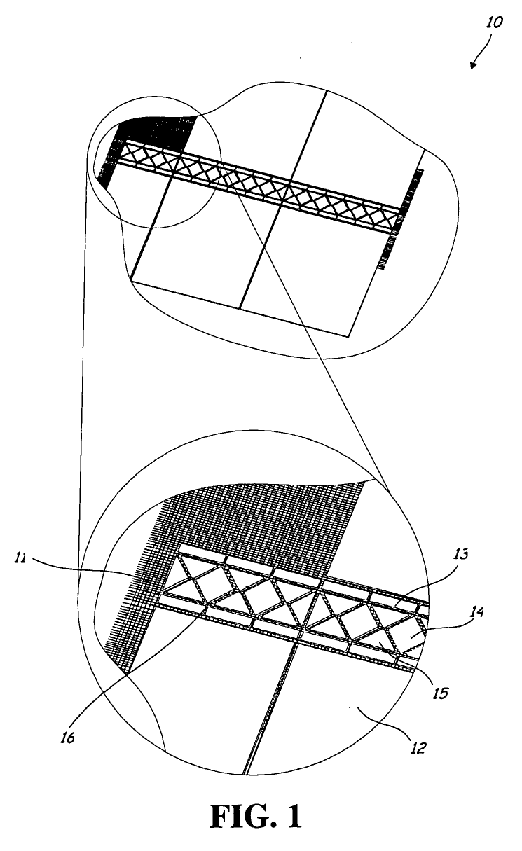

Referring now to FIG. 1, a top perspective view of a natural stone assembly 10 is shown. A plurality of natural stone pieces is assembled into a predetermined shape on flat table to affect a mold form. The natural stone assembly 10 may include, for example, but is not limited to, a large natural stone square 12, a small natural stone rectangle 13, a small natural stone square, a small natural stone triangle 15. The various stone pieces 12, 13, 14, and 15 are assembled into a predetermined shape, or design pattern. The stones in the natural stone assembly 10 are placed apart from one another such that there exists a plethora of stone gaps 16 between the various stone edges. A stone gap 16 allows for the mold later created from the natural stone assembly 10 to include portions closely resembling grout lines, similar to that in ceramic tile decorative displays.

The various stones 12, 13, 14, and 15, are natural and thus are porous and veinous. Such marks will therefore show on the mold created from the natural stone assembly 10 and produce cast polymer products nearly identical in appearance and surface texture as the natural stone assembly 10. The various natural stones 12, 13, 14, and 15 are held together to one another on the underside of the stone by securing each stone to the plastic net backing 11. The method by which the various natural stones 12, 13, 14, and 15 are held together may include means other than the plastic net backing 11, so long as the stones are held securely in place and allow for the various stone gaps 16 to remain. Grout is applied to the stone gaps or cracks (grout lines) on the mold form. The mold form, consisting of the arrayed natural stone assembly 10 and grout is sealed ad released with a polymer release system.

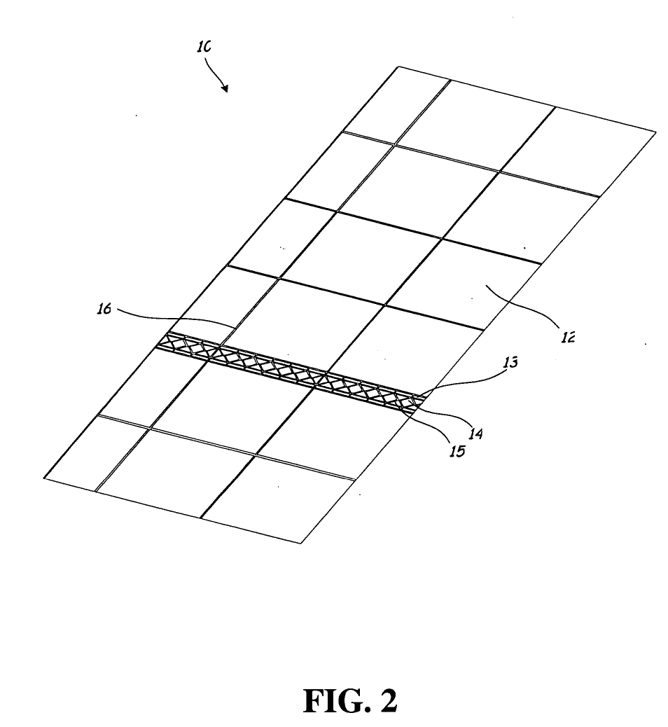

Referring now to FIG. 2, a top perspective view of a natural stone assembly 10 is shown. A plurality of natural stone pieces is assembled into a predetermined shape on flat table to affect a mold form. The natural stone assembly 10 may include, for example, but is not limited to, a large natural stone square 12, a small natural stone rectangle 13, a small natural stone square, and a small natural stone triangle 15. Predetermined quantities of the various stone pieces 12, 13, 14, and 15 are assembled into a predetermined shape, or design pattern. The stones in the natural stone assembly 10 are placed apart from one another such that there exists a plethora of stone gaps 16 between the various stone edges. The mold form, consisting of the arrayed natural stone assembly 10 and grout is sealed and released with a polymer release system.

A significant amount of trim detail work is done at this point to ensure that the edges of the mold are clean and appropriately shaped. Additionally, detail work is applied to the lines resembling grout lines in order to provide a textured surface similar to that of real grout. The lines resembling grout may be made to represent varying degrees of texture, such as providing a smooth line appearance or a rough texture feeling like sandpaper. This textured surface of these lines is obtained through the use of a mixture of polyester resin and calcium carbonate; however, other similar materials may be used to provide the texturing effect to the simulated grout lines.

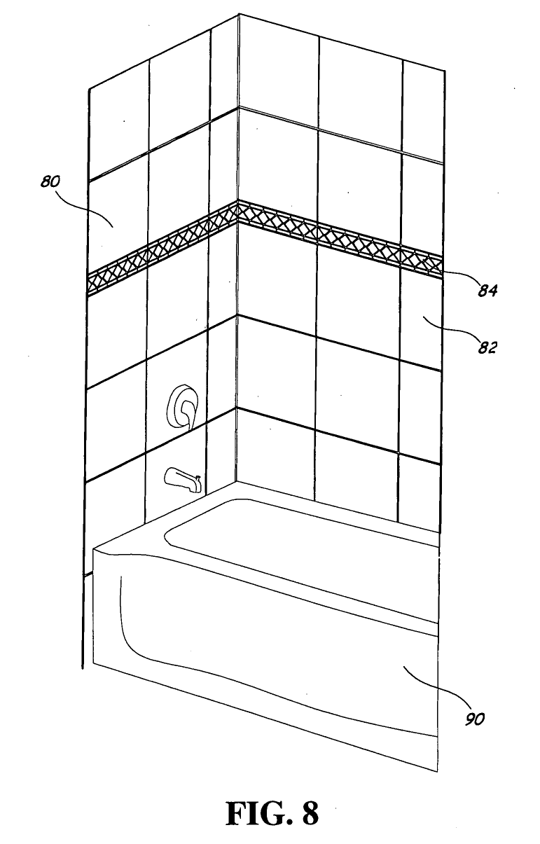

Alignment is critical at this point in order to ensure that when two panels are joined together in a corner joint, for example, as they would be in a tub/shower surround (see FIG. 8 and panels 80 and 82), that all horizontals lines resembling natural grout work are connected and continuous between panels.

The mold is sealed and released with a polymer release system to make it non-porous to prepare it for additional layers of fiberglass, resin, and waferboard. From the original prototype mold form a master mold will be made and from the master mold a plurality of casting molds will me made. Not shown are the multiple layers of the tooling gel-coat are sprayed onto to the prototype mold 22 to prepare and create a master mold. A skim coat layer comprised of one-ounce fiberglass is applied over the entire mold 22. The materials and layers placed over the mold while it is being constructed must be rolled and/or brushed to ensure that no sources of trapped air remain within the materials. Once it is ensured that all air bubbles have been dislocated and removed, two additional layers of a heavier-weight fiberglass are applied. On top of these additional layers of fiberglass, a layer of resin is applied. Once the final resin layer is applied, a waferboard, such as seven-sixteenths inch thick waferboard, is applied. Additionally, structural supports of either wooden or metal form are applied to the back of the mold 22. After the mold has cured, it is removed from the mold form. After the mold has cured further, it is released and sprayed with a tooling gel. The mold then has various layers of fiberglass and resin and waferboard applied, using brushes and rollers to remove trapped air. A wood or metal frame is then applied to the back of the master mold, to give the master mold rigidity. After the master mold has cured, it is removed from the mold. After the master mold has cured further, it is released and sprayed with tooling gel and the above steps of application of fiberglass, resin, waferboard, and framing are repeated. After the production mold has cured, it is removed from the master mold. After the production mold has cured further, it is released. The production mold is then sprayed with a production gel coat. After a pre-determined time, the mold is run along the conveyor lines to the pouring machine, and is filled with matrix material (cultured marble). The production mold is then moved to a curing area, using the conveyor lines. After the product is dried, it is removed from the production mold and is ready to be installed for use.

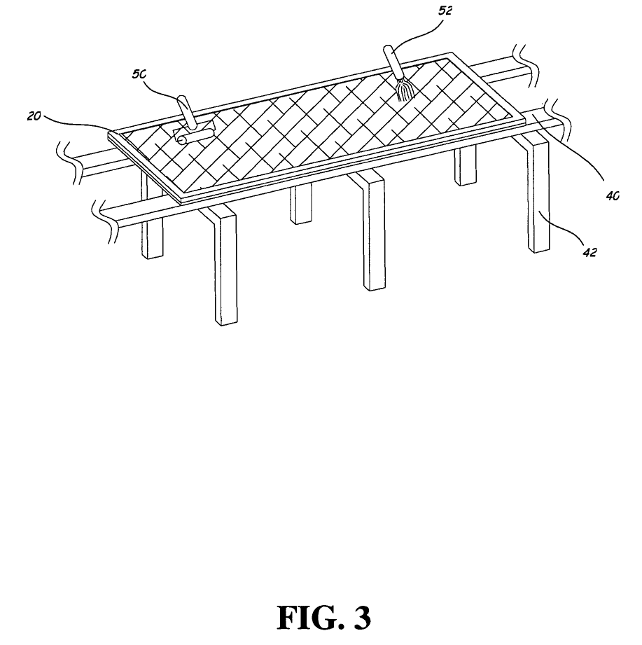

Referring now to FIG. 3, a top perspective view of a mold tray 20 and conveyor system 40 according to an embodiment of the present invention is shown. At various stages of the application, the materials and layers placed over the mold 22 while it is being constructed must be rolled and brushed to ensure that no sources of trapped air remain. A resin roller 50 and a resin brush 52 are both shown on the layer surface side of a mold 22.

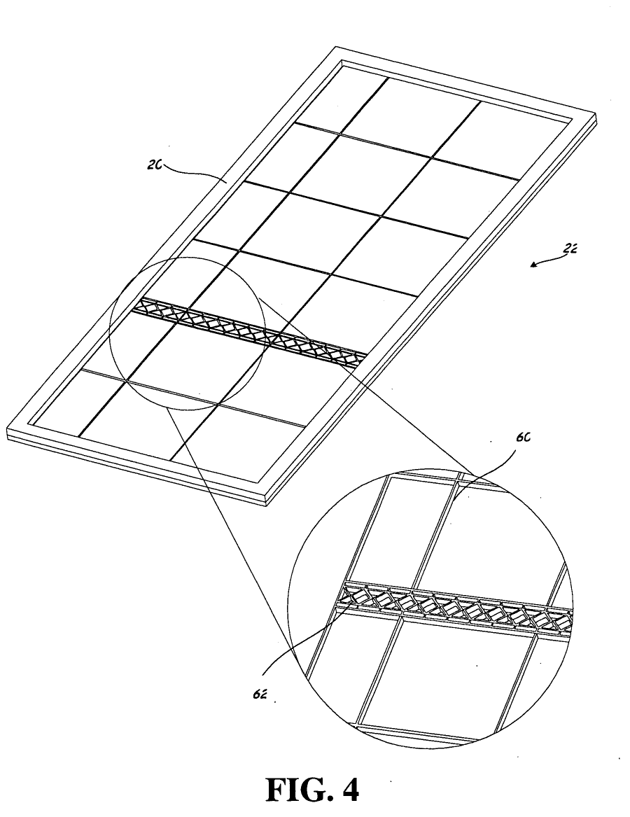

Referring now to FIG. 4, a top perspective view of a mold 22 is shown. The mold 22 is shown with mold ridges for grout simulation 60 and mold ridges for stone separation simulation 62. Additionally, all natural stone assembly 10 attributes, such as stone textures, marks, veins, natural blemishes, etc. are visible in the constructed mold 22 and will thus be a part of the final decorative cast polymer display panel, such as 80, 82, or 84, as shown in FIG. 8, that results from use of the mold 22.

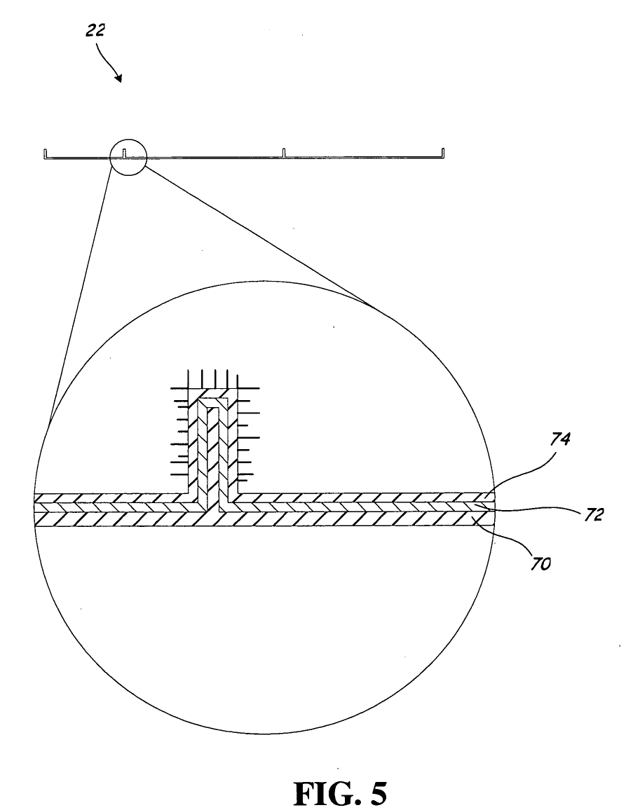

Referring now to FIG. 5, a side cross sectional view of the layers 70, 72, and 74, for example, applied onto the mold 22 while it is being made is shown. Although varying numbers and thicknesses of sprayed, poured, brushed, or rolled layers may be applied, this figure illustrates the application of three layers which may include, for example and not limited to, one or more gel-coat layers, one or more skin coat layers, one or more resin layers, a waferboard layer, and a fiberglass layer. Also illustrated in this figure is the raised portion of the layers, representing the mold components which make indentations resembling grout lines.

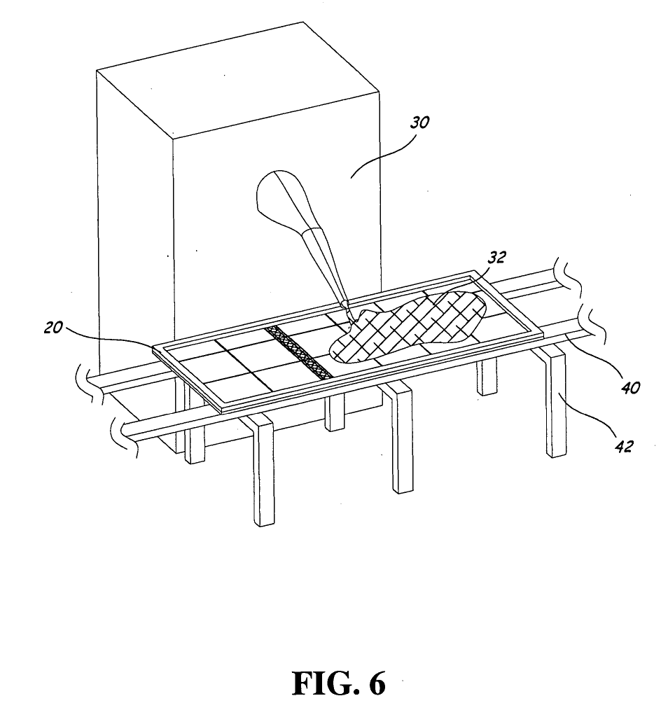

Referring now to FIG. 6, a top perspective view of a mold tray 20 and conveyor system 40 is shown. The mold tray 20 is shown placed atop rollers on a conveyor system 40 and conveyor support 42. A resin source 30 pouring machine provides a liquid resin 32 mixed matrix material, already well known in the art, but, for example which may be comprised of eighty percent crushed marble pieces and twenty percent polyester resin, which may be poured into a constructed mold in order to form a decorative cast polymer display panel resembling natural stonework.

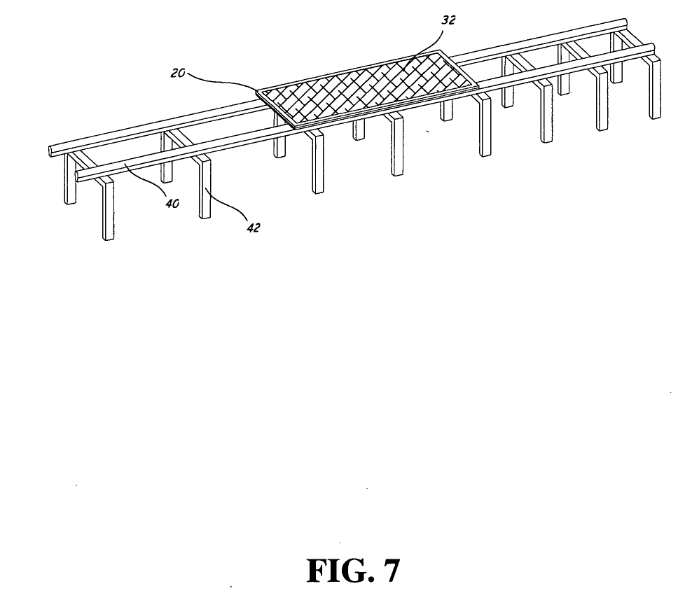

Referring now to FIG. 7, a top perspective view of a mold tray 20 and conveyor system 40 is shown. The mold tray 20 is shown placed atop rollers on a conveyor system 40 and conveyor support 42. The conveyor system 40 is used to transport the mold trays 20 to various locations. Once a mold 22 has received various application layers, it is to remain untouched for a predetermined time to settle, cure, arid harden.

Referring now to FIG. 8, a front perspective view of decorative panels 80, 82 made from the mold 22 resembling a natural stone assembly 10 is shown. Also shown is a decorative display panel, a listello 84, resembling detailed natural stone work. The left panel 80 and the back panel 82, including the listello 84 design pattern, are shown surrounding a traditional tub/shower 90. This figure shows in use the cast polymer panels created from a mold of the present invention.

Although the present invention has been illustrated and described with reference to preferred embodiments and examples thereof, it will be readily apparent to those of ordinary skill in the art that other embodiments and examples may perform similar functions and/or achieve similar results. For example: the actual number of layers of sealant, tooling gel-coat, skim coat, light fiberglass, heavier fiberglass, and resin may vary. Additionally, various means of applying brushing and rolling techniques may used. All such equivalent embodiments and examples are within the spirit and scope of the invention and are intended to be covered by the following claims.

What is claimed is:

1. A method of manufacturing a hardened mold resembling the appearance of natural stone work for use in constructing panels of molded cast polymer comprising the steps of:
arranging natural stonework material in a predetermined pattern and securing the natural stonework material to a backing to hold the natural stone work material in the predetermined pattern; and
applying material between a plurality of edges of the natural stonework material to simulate a texture to a plurality of stone gaps surrounding the natural stonework material.

2. The method of claim 1, further comprised of:
applying a sealant chemical layer covering the natural stonework material;
applying one or more layers of a tooling gel-coat over the sealant chemical layer;
applying one or more layers of a skim coat fiberglass over the sealant chemical layer;
removing air bubbles by one of a rolling or brushing technique;
applying one or more layers of a fiberglass;
applying one or more layers of a resin; and
allowing the layers to cure.

3. The method of claim 2, further comprised of applying a waferboard on top of the other layers.

4. The method of claim 2, further comprised of applying a wooden frame to provide structural support to the mold.

5. The method of claim 2, further comprised of applying a metal frame to provide structural support to the mold.

6. The method of claim 1, wherein the material applied between the plurality of edges of the natural stonework material, to simulate a texture to a plurality of stone gaps surrounding the natural stonework material, is comprised of a mixture of polyester resin and calcium carbonate.
